(19) United States
(12) Patent Application Publication
(10) Pub. No.: US 2005/0187123 A1
(43) Pub. Date: Aug. 25, 2005

(54) Composition for removal of odors and contaminants from carpet and method

(76) Inventors: Shulong Li, Spartanburg, SC (US); Richard A. Mayernik, Mauldin, SC (US)

Correspondence Address: MILLIKEN & COMPANY, 920 MILLIKEN RD (M-495), PO BOX 1926, SPARTANBURG, SC, 29304, US

(21) Appl. No.: 10/783,071

(22) Filed: Feb. 20, 2004

(51) Int. Cl. C11D 1/00

(52) U.S. Cl. 510/278

(57) ABSTRACT

The present disclosure relates to compositions useful for maintaining the clean impression of a carpet (that is, its scent and appearance) over an extended time despite occurrences that might damage the carpet surface. The composition, which includes an antimicrobial agent, an enzyme inhibitor, and, optionally, an aldehyde-containing aroma, can be used by a consumer to remove contaminants from the carpet and to prevent the odor associated with the decomposition of future contamination. Specifically, the composition has been shown effective in neutralizing odors associated with the decomposition of organic materials (such as urine or food spills) by absorbing and/or neutralizing the odor-generating source. A pre-treatment composition and methods for using are also disclosed.

### TECHNICAL FIELD

The present disclosure relates to compositions useful for maintaining the clean impression of a carpet (that is, its scent and appearance) over an extended time despite occurrences that might damage the carpet surface. The composition, which includes an antimicrobial agent, an enzyme inhibitor, and, optionally, an aldehyde-containing aroma compound, can be used by a consumer to remove contaminants from the carpet and to prevent the odor associated with the decomposition of present and future contamination. Specifically, the composition has been shown effective in neutralizing odors associated with the decomposition of organic materials (such as urine or food spills) by absorbing and/or neutralizing the odor-generating source. A pre-treatment composition and methods for using are also disclosed.

### BACKGROUND

“Contamination”, as defined herein, means the unintentional introduction of undesirable and potentially damaging materials onto a carpet surface, specifically including contaminants such as human or animal waste, food spills, and vomit. “Carpet”, as used herein, refers to a textile floor covering having a plurality of pile fibers and a backing surface, and specifically includes broadloom carpeting, area rugs, and mats.

People tasked with maintaining carpet in commercial and/or residential settings have often experienced problems with removal of odors associated with organic contamination. Such contamination may occur, for example, when food or drink is spilled onto a carpet surface. Contamination also occurs if an individual vomits on the carpet. Yet a third source of contamination is from human or animal urine, as may occur in homes with indoor pets or in health care or nursing facilities that care for patients suffering from incontinence.

In situations such as those described above, the contamination reaches the carpet surface and either remains on the surface or is absorbed by the pile fibers. The contaminant, which may or may not have foul odors inherent in the contaminant, will begin to decompose over time, if not removed. The decomposition process, in most instances, generates odor molecules as the organic contaminant breaks down. Clearly, this odor generation is problematic for maintaining a pleasant-smelling environment. Urine odors, for example, are particularly difficult to mask or neutralize.

There are several approaches used by those tasked with maintaining clean-appearing carpet. One approach is to clean the affected area with water and/or detergent. Another approach is to clean the affected area and then apply a fragrance-carrying compound to the surface or the air to mask the odor. These approaches have not been wholly sufficient or successful.

One reason that these approaches fail is that the cleaning technique is ineffective at removing the contaminant. Because the cleaning technique is ineffective at removing all of the contaminant, some source material remains in the carpet. As this source material decomposes, odor molecules emanate from the source, resulting in an undesirable situation for those in proximity to the contamination. Furthermore, the cleaning process leaves a residual amount of cleaning compositions in the carpet. Conventional wisdom holds that any remaining detergent or surfactant left in the carpet pile will “attract” dirt, resulting in a dirty or dingy-looking appearance over time.

A second reason that these approaches fail is because, rather than eliminating odors, they only mask the odors with fragrance. When an individual has completed his cleaning efforts, he may choose to use a scented powder or spray to restore the fresh scent of the carpet. Fragrances associated with scented powders or sprays provide temporary pleasant smells to the room in which they are used, but the malodors are again noticeable when the fragrance disperses.

Finally, using hot water or steam extraction to clean the carpet raises several issues. One issue is the availability, efficiency, and expense of the cleaning equipment. In some instances, individuals turn to professional cleaning services to perform this type of carpet maintenance. Another issue is the amount of water that is in contact with the carpet and how long it takes to dry. Water can seep through the carpet pile and into the carpet padding and/or sub-flooring, which then becomes susceptible to damage from mildew. Deterioration of the padding and sub-flooring can also be an issue. Hot water or steam extraction also leaves residual amounts of detergent or surfactant in the carpet pile, leading to problems that have been previously discussed.

The present disclosure addresses the shortcomings of the previous approaches. The present composition provides a cleaning composition that allows the contaminant to be removed before it breaks down and generates odor. The residual amount of composition that remains after cleaning is useful in preventing deterioration of future contaminants that contact the carpet and in aiding removal of future contaminants.

### SUMMARY

The cleaning composition described herein includes an antimicrobial agent, an enzyme inhibitor, and, optionally, an aldehyde-containing aroma. The present composition is applied as a liquid, preferably in conjunction with a powder cleaning composition. More preferably, the pile of the carpet has also been treated with a treatment composition comprising an antimicrobial agent, an enzyme inhibitor, and, optionally, an odor-absorbing compound. Most preferably, the carpet to which the composition is applied has a liquid barrier layer between the pile and the backing.

### DETAILED DESCRIPTION

The cleaning composition is used to maintain the fresh appearance and scent of clean carpet. The composition is preferably used on a periodic frequency, such as once a month or, more preferably, once every two weeks, to prevent the generation of odor from decomposition of organic contaminants. The cleaning composition can be used in a spray, in a carpet shampoo, as a liquid charge to a powder cleaning composition, and as a cleaning solution for water or steam extracting equipment.

The treatment composition is preferably applied to the pile layer of the carpet during manufacture, by application techniques such as impregnation, coating, foam coating, spraying, or the like. The treatment composition could also be incorporated in the barrier layer or backing layer of the carpet. The treatment composition includes an antimicrobial agent, an enzyme inhibitor, and, optionally, an odor-absorbing compound.

In one spray embodiment of the cleaning composition and the treatment composition, an exemplary relative proportion of components is as follows:
(a) from between 0.01% to about 10% by weight of an antimicrobial agent;
(b) from between 0.05% to about 10% by weight of an enzyme inhibitor;
(c) from between 0% to about 10% by weight of odor-absorbing compound;
(d) from between 0% to about 7% by weight of an aldehyde-containing aroma; and
(e) the percentage by weight of water is such that the total is 100%.

In one embodiment where a carrier powder is used, an exemplary relative proportion of components is as follows:
(a) from between 0.01% to about 10% by weight of an antimicrobial agent;
(b) from between 0.05% to about 10% by weight of an enzyme inhibitor;
(c) from between 0% to about 10% by weight of odor-absorbing compound;
(d) from between 0% to about 7% by weight of an aldehyde-containing aroma;
(e) from between 10% to about 50% by weight of water; and
(f) the percentage by weight of powder is such that the total is 100%.

It should also be noted that some compounds as are useful herein perform dual functions. For example, some antimicrobial agents (such as 2-bromo-2-nitro-1,3 propanedial) also act as enzyme inhibitors. Likewise, some odor-absorbing compounds (such as zinc ricinoleate) also act as enzyme inhibitors. It should also be noted that, although one compound may perform two functions, a synergistic effect is observed from the use of different compounds and, therefore, at least two different compounds are preferably used as the antimicrobial agent and the enzyme inhibitor.

The cleaning composition and the treatment composition contain an antimicrobial agent. The antimicrobial agent acts as a preservative and allows the contaminant to be removed (for example, during regular cleaning or maintenance) before the contaminant decomposes and generates odor. The antimicrobial component includes any organic or inorganic compound that effectively controls or inhibits the growth of odor-causing microorganisms, such as bacteria and fungus. Examples of such materials include silver zirconium phosphate, zinc oxide, and polyhexamethylene biguanide. Certain alcohols also are useful for this purpose.

Preferably, the antimicrobial agent is a formaldehyde-donor antimicrobial, such as N,N′-dimethylol 5,5-dimethyl hydantoin, N-methylol 5,5-dimethyl hydantoin, imidazolidinyl urea, cationic quaternary ammonium salt, sodium/potassium sorbate, sorbic acid, and grapefruit seed extract. Aldehyde-based antimicrobial agents, such as glutaraldehyde, may also be used. It has been found that aldehyde-donor antimicrobials are most effective at eliminating microbes and preventing contaminant decomposition that leads to unpleasant odors, especially those odors associated with urine decomposition. Metal salts are also effective for this purpose, but are less preferred because of their potential to adversely affect the carpet color and their deleterious environmental effects.

The cleaning composition and the treatment composition also include an enzyme inhibitor. Enzyme inhibitors, such as urease inhibitors useful for controlling ammonia generation from urine contamination, are desirable. Enzyme inhibitors include organic and inorganic salts of zinc, copper, zirconium, aluminum, silver, and tin, as well as organic compounds such as aldehydes (e.g., p-hydroxybenzyl aldehyde) and quaternary ammonium compounds. Urease inhibitors include (a) salts or complexes containing silver ions, zinc ions, or copper ions, (b) boric acids and borates, (c) salt of citric acid, (d) sorbic acid and its salt, (e) aldehydes, (f) bromo-nitro organic compounds, and (g) phophoamide compounds. Because of concern over the use of metal salts, bromo-nitro compounds and phosphoamide compounds are preferably used as enzyme inhibitors.

An odor-absorbing compound may be included in the treatment composition. The odor-absorbing compound is selected from activated carbon, zeolites, zinc oxide, cyclodextrin, and zinc ricinoleate. The preferred odor-absorbing compounds are zinc ricinoleate and cyclodextrin.

An aldehyde-containing aroma is preferred as an optional fragrance component in the cleaning composition. Examples of preferred fragrances include citral, cinnamic aldehyde, hexyl cinnamic aldehyde, benzyl aldehyde, benzyl salicylate, amyl cinnamic aldehyde, and vanillin. The most preferred of these is hexyl cinnamic aldehyde, which is commonly used to create a “fresh” scent in many consumer products, such as fabric softener.

Also optionally included in the cleaning composition are surfactants that enhance cleaning properties. Useful surfactants are ones that do not discolor the carpet, but that provide emulsifying properties for the other components in the cleaning composition.

In the treatment composition, the antimicrobial agent, the enzyme inhibitor, and the optional odor-absorbing compound are prepared for application to the carpet by combining the components with an amount of water appropriate for the application method. The treatment composition may be applied onto the carpet surface by spraying, by coating, by foam coating, by impregnation or the like. In cases where the treatment composition is applied as a foam, a foam stabilizing agent may also be used. The treatment composition can be applied to a carpet as part of the finishing process at the manufacturing location or as a post-treatment after the carpet has been installed.

The cleaning composition, as used by persons tasked with carpet cleaning and/or maintenance, can be sprayed directly onto the carpet surface in a concentrated form. Alternatively, and perhaps more preferred, a more dilute liquid cleaning composition is charged onto a cleaning powder composition (that is, sprayed onto the cleaning powder composition until the powder composition is damp). One particularly suitable cleaning powder composition for this purpose is described in U.S. Pat. No. 4,434,067 to Malone, assigned to Milliken Research Corporation and incorporated herein by reference.

The preferred, patented cleaning powder composition contains a particulate polymeric material, an inorganic salt adjuvant, and an aqueous or organic fluid component. Specifically, the powdered cleaning composition is provided consisting essentially of:
(a) about 100 parts by weight particulate polymeric material having an average particle size of from about 37 to about 105 microns in diameter, an oil absorption value of no less than about 90, and a bulk density of at least about 0.2 g/cc;
(b) from about 5 to about 400 parts by weight of an inorganic salt adjuvant having an average particle size of from about 45 to about 60 microns in diameter; and
(c) from about 5 to about 400 parts by weight of a fluid consisting essentially of 0 to 100 percent water containing sufficient surfactant to give a surface tension of less than about 40 dynes per centimeter and 100 to 0 percent of organic liquid selected from high boiling hydrocarbon solvents, tetrachloroethylene, methylchloroform, 1,1,2-trichloro-1,2,2,-trifluoroethane, an aliphatic alcohol containing from 1 to about 4 carbon atoms, and mixtures thereof.

It has been found that this particular compound is highly effective at removing a variety of contaminants from carpet, without creating any of the problems associated with wet cleaning techniques in which the carpet is saturated.

The following examples are intended to be representative of various embodiments of the present invention.

### EXAMPLE 1

One embodiment of the liquid cleaning composition was created comprising the following ingredients:
(a) as an antimicrobial agent, 5% by weight of sorbic acid, which is particularly effective against fungi- and yeast-containing contaminants;
(b) as enzyme inhibitors, 1% by weight of copper sulfate, 1% by weight of salicylic acid, and 0.5% by weight of zinc sulfate;
(c) as an odor-absorbing agent (and also as an enzyme inhibitor), 3% by weight of zinc ricinoleate, available as 30% active ingredient from Degussa under the trade name “TEGO SORB 30”;
(d) as aroma, 1% by weight of hexyl cinnamic. aldehyde, 1% by weight of cinnamic aldehyde, and 1% by weight of citral; and
(e) as solvent, water such that the total percentage equaled 100%.

The ingredients were combined and used to saturate a 2″ circle of carpet. The carpet was then blotted dry with paper towel such that the carpet circle retained about one gram of the solution. Then, 4 milliliters (mL) of 10% urea and 3 drops of 0.005% urease (type III, purchased from Sigma) were added separately to the treated carpet and to an untreated “control” carpet. Urease is an enzyme that causes urea to decompose and release ammonia, which is responsible for the characteristic pungent smell of urine odor.

Each carpet samples was sealed in a 250 mL plastic beaker. A small piece of nonwoven fabric impregnated with bromothymol blue indicator water solution was then used to monitor the presence of ammonia in the headspace of each beaker. This indicator solution is light yellow in the absence of ammonia, but turns to dark blue in the presence of ammonia.

Observations were made 1 hour, 2 hours, and 4 hours after the addition of the urea and urease solutions. After approximately only 10 minutes, the control carpet sample (untreated) showed the presence of ammonia. At no time during the observation period did the treated sample indicate the presence of ammonia. This result indicates that the chemical cleaning compound described above is capable of inhibiting urease activity and preventing ammonia generation from the decomposition of urea.

Also worth noting, the untreated control sample generated significant ammonia odor in the headspace of the beaker after 2 hours. Although the treated sample generated ammonia odor when left overnight, it is clear that the cleaning composition demonstrated effective human urine odor control properties.

In comparison, commercially available products such as Fabreze, Syon 5, and Woolite Pet cleaner mask the odor of ammonia, but the presence of ammonia is detectable by this method after less than half an hour on average.

### EXAMPLE 2

An alternate embodiment of the liquid cleaning composition was created comprising the following ingredients:
(a) as an antimicrobial agent, 3% by weight of sodium sorbate and 0.8% of monomethylol dimethyl hydantoin, a formaldehyde-donor antimicrobial agent sold under the trade name “DANTOGUARD 2000” by Lonza, Inc. of Fair Lawn, N.J.;
(b) as enzyme inhibitors, 0.3% of citric acid;
(c) as an odor-absorbing agent (and also as enzyme inhibitor), 3% by weight of zinc ricinoleate, available as 30% active ingredient from Degussa sold under the trade name “TEGO SORB 30”;
(d) as aroma, 1% by weight of hexyl cinnamic aldehyde, 1% by weight of a fragrance blend sold as “Green Downy-type Fragrance H20-type” from Berge'; and
(e) as solvent, water such that the total percentage equaled 100%.

Zinc ricinoleate is effective at absorbing some of the odor associated with urine as a contaminant. The addition of sodium sorbate. and monomethylol dimethyl hydantoin, along with the inclusion of hexyl cinnamic aldehyde fragrance, makes the cleaning composition more effective at eliminating malodors from human urine than that of EXAMPLE 1. (Or “particularly effective” if you don't want to compare the two)

### EXAMPLE 3

A liquid cleaning composition was created similar to that of EXAMPLE 2, which was added to a urea formaldehyde powder having 30% moisture content, thereby creating a damp powder cleaning composition comprising the following ingredients:
(a) as an antimicrobial agent, 3% by weight of sodium sorbate and 0.8% of monomethylol dimethyl hydantoin, a formaldehyde-donor antimicrobial agent sold under the trade name “DANTOGUARD 2000” by Lonza, Inc. of Fair Lawn, N.J.;
(b) as enzyme inhibitors, 0.3% of citric acid;
(c) as an odor-absorbing agent (and also as enzyme inhibitor), 3% by weight of zinc ricinoleate, available as 30% active ingredient from Degussa sold under the trade name “TEGO SORB 30”;
(d) as aroma, 1% by weight of hexyl cinnamic aldehyde, 1% by weight of a fragrance blend sold as “Green Downy-type Fragrance H20-type” from Berge';
(e) 5% by weight of water; and
(f) as carrier, urea formaldehyde powder such that the total percentage equaled 100%.

### EXAMPLE 4

Yet another embodiment of the liquid cleaning composition was created comprising the following ingredients:
(a) as an antimicrobial agent, 0.05% by weight of 2-bromo-2-nitro-1,3 propanedial;
(b) as an enzyme inhibitor, 0.3% by weight of citric acid;
(c) as a surfactant to aid in suspending the components in solution, 2% by weight of “Triton XL80N” sold by Dow Chemical Company;
(d) as aroma, 1% by weight of hexyl cinnamic aldehyde; and
(e) as solvent, water such that the total percentage equaled 100%.

This composition completely prevented the generation of detectable ammonia odors when tested according to Test 1 and Test 2, as will be described.

### EXAMPLE 5A

This example was-created as a comparative example for the compositions described in EXAMPLES 5B and 5C. In this composition, the antimicrobial component was purposely omitted. The comparative treatment composition comprised:
(a) as an odor-absorbing agent (and also as enzyme inhibitor), 3% by weight of zinc ricinoleate, available as 30% active ingredient from Degussa sold under the trade name “TEGO SORB 30”;
(b) as an enzyme inhibitor, 0.3% by weight of citric acid;
(c) as solvent, water such that the total percentage equaled 100%.

### EXAMPLE 5B

This example describes a first embodiment of a treatment composition useful for application to the carpet surface during manufacturing or after installation. The treatment composition comprises:
(a) as antimicrobial compound (and also an enzyme inhibitor), 2-bromo-2-nitro-1,3 propanedial;
(b) as an enzyme inhibitor, 0.3% by weight of citric acid;
(c) as solvent, water such that the total percentage equaled 100%.

### EXAMPLE 5C

This example describes a second embodiment of a treatment composition useful for application to the carpet surface during manufacturing or after installation. The treatment composition comprises:
(a) as antimicrobial compound (and also an enzyme inhibitor), 0.02% by weight of 2-bromo-2-nitro-1,3 propanedial;
(b) as an antimicrobial compound, 0.5% by weight of of monomethylol dimethyl hydantoin, a formaldehyde-donor antimicrobial agent sold under the trade name “DANTOGUARD 2000” by Lonza, Inc. of Fair Lawn, N.J.;
(c) as an enzyme inhibitor, 0.3% by weight of citric acid; and
(d) as solvent, water such that the total percentage equaled 100%. 20 mL of EXAMPLES 5A, 5B, and 5C were allowed to soak into 4″×4″ square carpet samples. The carpet samples were dried at about 110° C. for 20 minutes to evaporate the water, leaving (on EXAMPLES 5B and 5C) a thin coating of antimicrobial compound and enzyme inhibitor on the yarns of the carpet pile. Other trials in which samples were dried at about 300° F. and at about 370° F. showed decrease efficacy, but the samples were still functional.

When tested using Test 1, as will be described, the three carpet treatments prevented the generation of detectable amounts of ammonia.

When tested using Test 2, only EXAMPLES 5B and 5C were successful at preventing the generation of odor for one month, thus supporting the hypothesis that the combination of an antimicrobial component and an enzyme-inhibiting component is most effective.

### Testing of Exemplary Embodiments

The following tests were conducted to demonstrate the effectiveness of the present cleaning composition at controlling human urine odor.

### Test 1: Urease Inhibition Test

Three carpet samples, having been cleaned using different methods, were. used in this test. All of the samples were 15″×15″ carpet squares, constructed with a liquid barrier layer between the pile face yarns and the foam backing and a silver zirconium phosphate antimicrobial agent in the back-coating.

Sample A was cleaned using the composition of Examples 2 and 3 described above. The carpet was sprayed with the composition of Example 2, in a fine mist. The powder composition of Example 3 was then brushed into the carpet. Then, the carpet was vacuumed, using a commercially available vacuum cleaner.

Sample B was cleaned using a commercially available liquid cleaning solution for carpet, which includes as its active ingredient an Australian tea tree extract. The carpet was saturated with the cleaning solution and then subjected to cleaning with an extraction-type vacuum cleaner.

Sample C was cleaned using only water with an extraction-type vacuum cleaner. No cleaning compositions were used.

The test procedure will now be described. For each sample, 40 ml of fresh human urine was applied to the carpet pile after cleaning. Each sample was sealed inside a 2 mil thick plastic bag to prevent evaporation of moisture and odors. The samples were stored inside the sealed bags for ten days, after which human judges were asked to evaluate, on a scale of 1 to 10, the odor in the headspace of the bag. Using this scale, 1 indicated the worst odor and 10 indicated the most pleasant odor.

After being assessed by the judges, the carpet samples were removed from the bags and cleaned using the same procedures as described above. Another 40 mL of fresh human urine was applied to each carpet sample. Each sample was then placed in a clean 2 mil thick plastic bag, where the sample remained for a total of 5 days. At the end of the 5 days, the human judges again evaluated the odor in the headspace of the bags using the same 1 to 10 scale. The pH of the headspace was also evaluated, using a pH indicator strip moist with distilled water, to detect the presence of ammonia (pH values higher than 7 indicate the presence of ammonia).

TABLE 1 shows the results of TEST 1: Urease Inhibition Test.

TABLE 1
Results of Urease Inhibition Test

| Sample ID | Cleaning Method | Headspace pH | Odor Rating |
|---|---|---|---|
| A | Cleaning Composition + | 5 | 8 |
| | Vaccum | | |
| B | Commercially Available | 9 | 2 |
| | Cleaning Liquid + Extraction | | |
| C | Water + Extraction | 10 | 1 |

The results above indicate that the present cleaning composition and composition are effective in controlling human urine odors on carpet and in preventing ammonia generation.

### Test 2: Odor Removal Test

In this experiment, human urine was collected and stored for 10 days in a sealed bottle. Strong ammonia and other odors developed. 10 mL of the aged urine was applied to an 8″×8″ carpet sample, and the carpet was allowed to sit for 2 hours before being cleaned with the present liquid cleaning composition as used with the powder cleaning composition described herein. The powder cleaning composition was dampened with the present liquid cleaning composition and then sprinkled onto the carpet. The cleaning composition was brushed into the carpet and then removed by vacuuming.

The odor of the carpet sample was evaluated following cleaning and two weeks after cleaning to determine whether the cleaning composition was effective at removing odor. No ammonia or other offensive odors were detected at either time.

Having been evaluated, the recently cleaned sample was subjected to another round of testing, in which an additional 10 mL of human urine were added to the carpet. The carpet sample was then placed into a sealed plastic bag to prevent evaporation of the moisture and dispersion of any generated odors.

After ten days storage at room temperature, the sample was evaluated to determine whether the residual cleaning composition remaining in the carpet was effective at preventing the generation. of odors from later-applied contaminants. No ammonia or other odors were detected, proving that the cleaning composition was effective in preventing the generation of odors.

### Conclusions

The tests conducted indicate that the compositions described herein, which comprise an antimicrobial compound and an enzyme inhibitor, are effective at removing existing contaminants and their odors from carpet, at preventing recurrence of odors from degeneration of later applied contaminants, and at maintaining the desired appearance and smell of carpet cleaned according to the teachings herein. For these reasons, the present compositions represent a useful advance over the prior art.

1. An aqueous composition useful for maintaining a carpet's desired appearance and smell, said composition comprising:
(a) at least one antimicrobial compound; and
(b) at least one enzyme inhibitor.

2. The composition of claim 1, wherein said antimicrobial compound is from about 0.01% to about 10% by weight of said composition; and said enzyme inhibitor is from about 0.05% to about 10% by weight of said composition.

3. The composition of claim 1, wherein said antimicrobial compound is selected from the group consisting of silver zirconium phosphate, zinc oxide, polyhexamethylene biguanide, and 2-bromo-2-nitro-1,3-propanedial.

4. The composition of claim 1, wherein said antimicrobial compound is a formaldehyde-donor antimicrobial compound.

5. The composition of claim 4, wherein said formaldehyde-donor antimicrobial agent is selected from the group consisting of N,N′-dimethylol 5,5-dimethyl hydantoin, N-methylol 5,5-dimethyl hydantoin, imidazolidinyl, urea, cationic quaternary ammonium salt, sodium sorbate, potassium sorbate, sorbic acid, and grapefruit seed extract.

6. The composition of claim 5, wherein said formaldehyde-donor antimicrobial agent is N-methylol 5,5-dimethyl hydantoin.

7. The composition of claim 1, wherein said enzyme inhibitor is selected from the group consisting of organic and inorganic salts of zinc, copper, zirconium, aluminum, silver, and tin; aldehydes; quaternary ammonium compounds; salts containing ions selected from the group consisting of silver, zinc, and copper; complexes containing ions selected from the group consisting of silver, zinc, and copper; boric acids and borates; salt of citric acid; sorbic acid and its salt; bromo-nitro compounds; and phosphoamide compounds.

8. The composition of claim 7, wherein said enzyme inhibitor is a bromo-nitro compound.

9. The compound of claim 8, wherein said bromo-nitro compound is 2-bromo-2-nitro-1,3-propanedial.

10. The composition of claim 1, further comprising an odor-absorbing compound selected from the group consisting of activated carbon, zeolites, zinc oxide, cyclodextrin, and zinc ricinoleate.

11. The composition of claim 10, wherein said odor-absorbing compound is zinc ricinoleate.

12. The composition of claim 10, wherein said odor-absorbing compound is from about 0% to about 10% by weight of said composition.

13. The composition of claim 1, further comprising an aldehyde-containing aroma compound selected from the group consisting of citral, cinnamic aldehyde, hexyl cinnamic aldehyde, benzyl aldehyde, benzyl salicylate, amyl cinnamic aldehyde, and vanillin.

14. The composition of claim 13, wherein said aroma compound is hexyl cinnamic aldehyde.

15. The composition of claim 13, wherein said aroma compound is from about 0% to about 7% by weight of said composition.

16. The composition of claim 1, further comprising (c) an odor-absorbing compound selected from the group consisting of activated carbon, zeolites, zinc oxide, cyclodextrin, and zinc ricinoleate, and (d) an aldehyde-containing aroma compound selected from the group consisting of citral, cinnamic aldehyde, hexyl cinnamic aldehyde, benzyl aldehyde, benzyl salicylate, amyl cinnamic aldehyde, and vanillin.

17. The composition of claim 1, wherein said composition is incorporated within urea formaldehyde powder having a moisture content of about 30%, until said powder is damp.

18. A method for removing contaminants from carpet, said method comprising:
(a) saturating the carpet at the location of a contaminant with an aqueous cleaning composition comprising (i) at least one antimicrobial compound and (ii) at least one enzyme inhibitor; and
(b) blotting the contaminant with an absorbent material.

19. The method of claim 18, wherein said antimicrobial compound is from about 0.01% to about 10% by weight of said composition; and said enzyme inhibitor is from about 0.05% to about 10% by weight of said composition.

20. The method of claim 18, wherein said chemical composition further includes an aldehyde-containing aroma compound selected from the group consisting of citral, cinnamic aldehyde, hexyl cinnamic aldehyde, benzyl aldehyde, benzyl salicylate, amyl cinnamic aldehyde, and vanillin.

21. The method of claim 20, wherein said aroma compound is from about 0% to about 7% by weight of said chemical composition.

22. The method of claim 18, wherein said chemical composition further includes an odor-absorbing compound selected from the group consisting of activated carbon, zeolites, zinc oxide, cyclodextrin, and zinc ricinoleate.

23. The method of claim 22, wherein said odor-absorbing compound is from about 0% to about 10% by weight of said chemical composition.

24. A method for maintaining a carpet's desired appearance and smell, said method comprising:
(a) applying a chemical composition to the carpet, said composition comprising (i) at least one antimicrobial compound and (ii) at least one enzyme inhibitor;
(b) vacuuming the carpet to remove most of said chemical composition; and
(c) repeating steps (a) and (b) on a periodic frequency.

25. The method of claim 24, wherein said chemical composition further includes an aldehyde-containing aroma compound selected from the group consisting of citral, cinnamic aldehyde, hexyl cinnamic aldehyde, benzyl aldehyde, benzyl salicylate, amyl cinnamic aldehyde, and vanillin.

26. The method of claim 24, wherein said chemical composition further includes an odor-absorbing compound selected from the group consisting of activated carbon, zeolites, zinc oxide, cyclodextrin, and zinc ricinoleate.

27. The method of claim 24, wherein said chemical composition further comprises a urea formaldehyde powder that is combined with said antimicrobial agent and said enzyme inhibitor, whereby said antimicrobial agent and said enzyme inhibitor are absorbed into said urea formaldehyde powder.

28. The method of claim 27, wherein said antimicrobial compound is from about 0.01% to about 10% by weight of said chemical composition; said enzyme inhibitor is from about 0.05% to about 10% by weight of said chemical composition; water is from about 10% to about 50% by weight of said chemical composition; and the percentage of said urea formaldehyde powder is such that the total equals 100%.

29. The method of claim 27, wherein said chemical composition further includes an aldehyde-containing aroma compound selected from the group consisting of citral, cinnamic aldehyde, hexyl cinnamic aldehyde, benzyl aldehyde, benzyl salicylate, amyl cinnamic aldehyde, and vanillin.

30. The method of claim 27, wherein said chemical composition further includes an odor-absorbing compound selected from the group consisting of activated carbon, zeolites, zinc oxide, cyclodextrin, and zinc ricinoleate.

31. A method for removing contaminants from carpet and maintaining the carpet's desired appearance and smell, said method comprising:
(a) applying an aqueous cleaning composition comprising (i) at least one antimicrobial compound and (ii) at least one enzyme inhibitor; and
(b) removing most of said cleaning composition using an extraction machine.

32. The method of claim 31, wherein said antimicrobial compound is from about 0.01% to about 10% by weight of said composition; and said enzyme inhibitor is from about 0.05% to about 10% by weight of said composition.

33. The method of claim 31, wherein said chemical composition further includes an aldehyde-containing aroma compound selected from the group consisting of citral, cinnamic aldehyde, hexyl cinnamic aldehyde, benzyl aldehyde, benzyl salicylate, amyl cinnamic aldehyde, and vanillin.

34. The method of claim 33, wherein said aroma compound is from about 0% to about 7% by weight of said chemical composition.

35. The method of claim 31, wherein said chemical composition further includes an odor-absorbing compound selected from the group consisting of activated carbon, zeolites, zinc oxide, cyclodextrin, and zinc ricinoleate.

36. The method of claim 35, wherein said odor-absorbing compound is from about 0% to about 10% by weight of said chemical composition.

37. A carpet comprising a pile upper surface and at least one backing surface attached to said pile upper surface, said pile upper surface comprising yarns that are at least partially coated with an antimicrobial compound and an enzyme inhibitor.

38. The carpet of claim 37, wherein said carpet further comprises a liquid barrier layer between said pile upper surface and said backing surface.

39. The carpet of claim 37, wherein said antimicrobial compound is selected from the group consisting of silver zirconium phosphate, zinc oxide, polyhexamethylene biguanide, N,N′-dimethyol-5,5-dimethyl hydantoin, N-methyol-5,5-dimethyl hydantoin, imidazolidinyl urea, cationic quaternary ammonium salt, sodium sorbate, potassium sorbate, sorbic acid, and grapefruit seed extract.

40. The carpet of claim 39, wherein said antimicrobial compound is N-methyol-5,5-dimethyl hydantoin.

41. The carpet of claim 37, wherein said enzyme inhibitor is selected from the group consisting of organic and inorganic salts of zinc, copper, zirconium, aluminum, silver, and tin; aldehydes; quaternary ammonium compounds; salts containing ions selected from the group consisting of silver, zinc, and copper; complexes containing ions selected from the group consisting of silver, zinc, and copper; boric acids and borates; salt of citric acid; sorbic acid and its salt; bromo-nitro compounds; and phosphoamide compounds.

42. The carpet of claim 41, wherein said enzyme inhibitor is a bromo-nitro compound.

43. A method of treating a carpet to maintaining the appearance and smell of a carpet, said method comprising the steps of:
(a) applying an aqueous cleaning composition comprising (i) at least one antimicrobial compound and (ii) at least one enzyme inhibitor; and
(b) drying said carpet.

44. The method of claim 43, wherein said drying occurs at a temperature at no greater than 370° F.
